(19) United States
(12) Patent Application Publication
(10) Pub. No.: US 2014/0085189 A1
(43) Pub. Date: Mar. 27, 2014

(54) LINE-OF-SIGHT DETECTION APPARATUS, LINE-OF-SIGHT DETECTION METHOD, AND PROGRAM THEREFOR

(71) Applicant: Renesas Micro Systems Co., Ltd., Yokohama-shi (JP)

(72) Inventor: Shinya SHIMASAKI, Kanagawa (JP)

(73) Assignee: Renesas Micro Systems Co., Ltd., Yokohama-shi (JP)

(21) Appl. No.: 14/036,546

(22) Filed: Sep. 25, 2013

(30) Foreign Application Priority Data
Sep. 26, 2012 (JP) 2012-212701

(51) Int. Cl. G06F 3/01

(52) U.S. Cl. CPC G06F 3/013
USPC 345/156

(57) ABSTRACT

A line-of-sight detection apparatus that specifies a point-of-regard of a subject within a object includes: a photographing unit outputting a photographed image of the subject and a zoom value; a cornea determination unit discriminating a cornea image of the subject from the image; a reference point specifying unit specifying an eyeball center of the subject based on the cornea image and specifying a reference point based on the eyeball center; a distance measurement unit specifying a zoom value indicating a predetermined size of the cornea image and specifying a distance from the cornea to the object based on the zoom value; a line-of-sight movement amount specifying unit specifying a cornea movement amount based on a cornea image movement amount and specifying a line-of-sight movement amount based on the cornea movement amount; and a point-of-regard specifying unit specifying the point-of-regard based on the reference point and line-of-sight movement amount.

### CROSS-REFERENCE TO RELATED APPLICATIONS

This application is based upon and claims the benefit of priority from Japanese patent application No. 2012-212701, filed on Sep. 26, 2012, the disclosure of which is incorporated herein in its entirety by reference.

### BACKGROUND

The present invention relates to a line-of-sight detection apparatus, a line-of-sight detection method, and a program therefor, and more particularly, to a technique for detecting a point of regard which is a position on a screen being viewed by a subject.

In recent years, the line-of-sight detection has been attracting attention as a user interface for care support devices, tablets, and the like for patients suffering from amyotrophic lateral sclerosis (hereinafter referred to as “ALS”). The ALS is an intractable disease that results in restricting the movement of muscles and making it difficult to speak. There is a strong demand for the line-of-sight detection as communication means in the care support devices for ALS patients. In the field of tablets, it is expected to improve the convenience by using the line-of-sight detection instead of the function of selecting an object within a screen of a tablet with a finger. Also, in the field of smart TVs, the line-of-sight detection has been attracting attention as a new user interface that replaces a remote controller, such as channel switching and a power-off function during unoccupied hours.

As a line-of-sight detection technique, it is general to specify a line of sight such that a light source such as an infrared ray or LED is applied to an eyeball of a subject and reflected light from the eyeball is captured by a camera. In the case of detecting a line of sight according to this technique, preparation is required to eliminate an error between the line of sight of the subject and the position (point of regard) of the line of sight on a screen of a line-of-sight detection apparatus. The point of regard is specified from the line of sight of the subject. The term “preparation” herein described refers to an adjustment to be carried out prior to the use of the line-of-sight detection apparatus in order to absorb the individual difference of each subject. In this technique, if the usage environment, such as the distance between the subject and the line-of-sight detection apparatus, is changed during the use of the line-of-sight detection apparatus, it is necessary to readjust the line-of-sight detection apparatus (the readjustment carried out during the use of the line-of-sight detection apparatus is hereinafter referred to as “calibration”) (see Japanese Unexamined Patent Application Publication No. 2009-297323, for example).

### SUMMARY

The preparation and calibration are generally carried out such that each subject follows the four corners of the screen of the line-of-sight detection apparatus with his or her eyes, or gazes at one point of the screen for several seconds. This is troublesome for each subject. Accordingly, there is a demand for the line-of-sight detection which eliminates the need for preparation for each subject and which requires no calibration even when the environment is changed during the use of the line-of-sight detection apparatus.

Other problems to be solved and novel features will become apparent from the description provided herein and the accompanying drawings.

A first aspect of the present invention is a line-of-sight detection apparatus that specifies a point of regard indicating a position at which a subject gazes within a substantially planar object, the line-of-sight detection apparatus including: a photographing unit that photographs the subject and outputs an image obtained by the photographing and a zoom value, the photographing unit having a zoom function; a cornea determination unit that discriminates an image of a cornea of the subject from the image; a reference point specifying unit that specifies a center of an eyeball of the subject based on the image of the cornea, and specifies, as a reference point, an intersection between the object and a perpendicular line from the center of the eyeball to the object; a distance measurement unit that specifies a zoom value indicating a predetermined size of the image of the cornea, and specifies a distance from the cornea to the object based on the zoom value; a line-of-sight movement amount specifying unit that specifies a movement amount of the cornea based on a movement amount of the image of the cornea, and specifies a line-of-sight movement amount on the object based on the movement amount of the cornea and the distance from the cornea to the object; and a point-of-regard specifying unit that specifies the point of regard based on the reference point and the line-of-sight movement amount.

A second aspect of the present invention is a line-of-sight detection method that specifies a point of regard indicating a position at which a subject gazes within a substantially planar object, the line-of-sight detection method including: a photographing step of photographing, by a photographing unit having a zoom function, the subject, and outputting an image obtained by the photographing and a zoom value; a cornea determination step of discriminating an image of a cornea of the subject from the image; a reference point specifying step of specifying a center of an eyeball of the subject based on the image of the cornea, and specifying, as a reference point, an intersection between the object and a perpendicular line from the center of the eyeball to the object; a distance measurement step of specifying a zoom value indicating a predetermined size of the image of the cornea, and specifying a distance from the cornea to the object based on the zoom value; a line-of-sight movement amount specifying step of specifying a movement amount of the cornea based on a movement amount of the image of the cornea, and specifying a line-of-sight movement amount on the object based on the movement amount of the cornea and the distance from the cornea to the object; and a point-of-regard specifying step of specifying the point of regard based on the reference point and the line-of-sight movement amount.

A third aspect of the present invention is a non-transitory computer readable medium storing a program for causing a computer to execute the line-of-sight detection method described above.

According to exemplary aspects of the present invention, it is possible to provide a line-of-sight detection apparatus, a line-of-sight detection method, and a program therefor, which eliminate the need for pre-adjustment and readjustment.

### BRIEF DESCRIPTION OF THE DRAWINGS

The above and other aspects, advantages and features will be more apparent from the following description of certain embodiments taken in conjunction with the accompanying drawings, in which:

FIG. 1 is a diagram showing a configuration according to an embodiment of the present invention;

FIG. 2 is a diagram showing an implementation example of an embodiment of the present invention;

FIG. 3 is a flowchart showing processes according to an embodiment of the present invention;

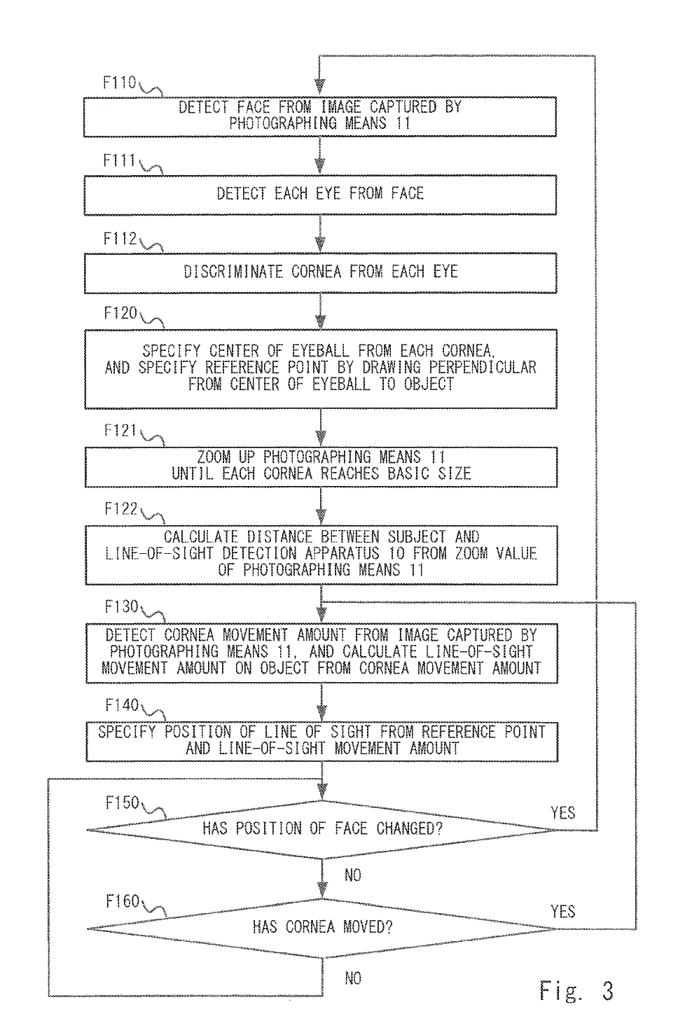

FIG. 4 is a diagram showing the significance of initial parameters in an embodiment of the present invention;

FIG. 5 is a diagram showing the concept of a distance measurement process in an embodiment of the present invention;

FIG. 6 is a diagram showing the concept of a line-of-sight movement amount specifying process in an embodiment of the present invention;

FIG. 7 is a diagram showing the concept of the line-of-sight movement amount specifying process in an embodiment of the present invention;

FIG. 8 is a diagram showing a line-of-sight measurement device of a related art;

FIG. 9 is a diagram showing the line-of-sight measurement device of the related art;

FIG. 10 is a flowchart showing operation of the line-of-sight measurement device of the related art; and

FIG. 11 is a diagram showing the line-of-sight measurement device of the related art.

### DETAILED DESCRIPTION

First, a line-of-sight measurement device disclosed in Japanese Unexamined Patent Application Publication No. 2009-297323 will be described for comparison with an embodiment of the present invention.

The line-of-sight measurement device disclosed in Japanese Unexamined Patent Application Publication No. 2009-297323 acquires an eyeball image, which is an image of an eyeball where light is reflected from a predetermined light source, for a subject viewing a predetermined screen. Further, the line-of-sight measurement device calculates an optical axis, which connects the center of curvature of a cornea and the center of a pupil, from the eyeball image, calculates a difference between the optical axis and a visual axis, which is an axis connecting a fovea and the center of curvature of the cornea, by use of the calculated optical axis, and calculates a point of regard of the subject on the screen, based on the difference between the optical axis and the visual axis.

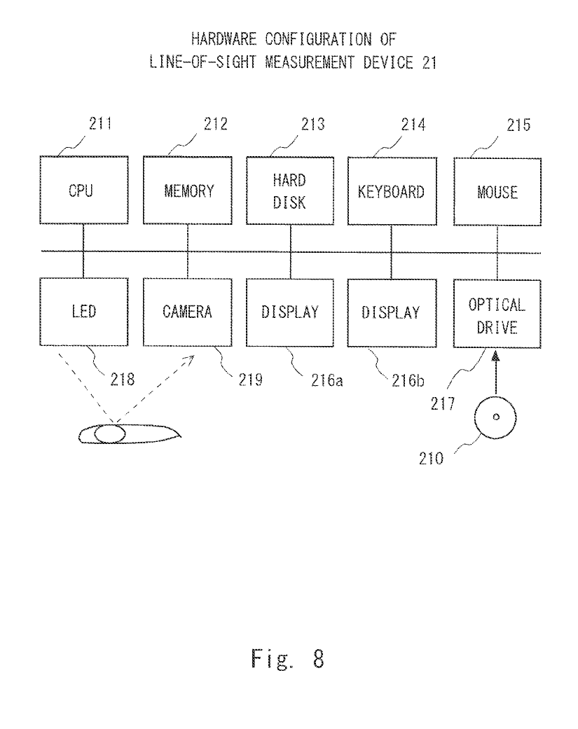

As shown in FIG. 8, a line-of-sight measurement device 21 includes a CPU 211, a memory 212, a hard disk 213, a keyboard 214, a mouse 215, displays 216a and 216b, an optical drive 217, an LED 128, and a camera 219.

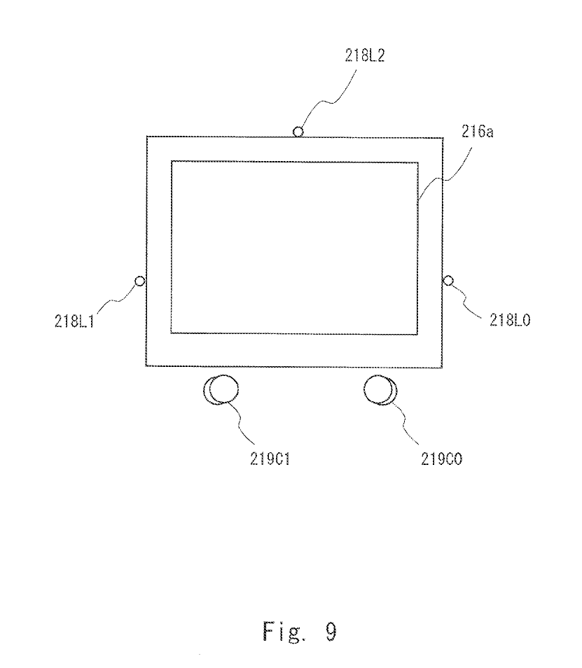

Out of these components, the display 216a displays an image to be viewed by the subject whose line of sight is to be measured. The display 216b displays the eyeball image of the subject, which is captured by stereo cameras 219C0 and 219C1, for the subject of the line-of-sight measurement device 21 to confirm the image. LEDs 218L0, 218L1, and 128L2 emit light toward the subject whose line of sight is to be measured by the line-of-sight measurement device 21. The LEDs 218L0 to 218L2 are arranged in the manner as shown in FIG. 9 to avoid problems inherent in the shape of a cornea and the reflection outside a cornea. The LED 218L0 is disposed at a position in contact with a frame which is located on the right side of the display 216a when viewed from the subject side, and the LED 218L1 is disposed at a position in contact with a frame which is located on the left side of the display 216a when viewed from the subject side. The stereo cameras 219C0 and 219C1 are disposed below the display in order to deal with subjects with half-closed eyes or slit eyes, for example.

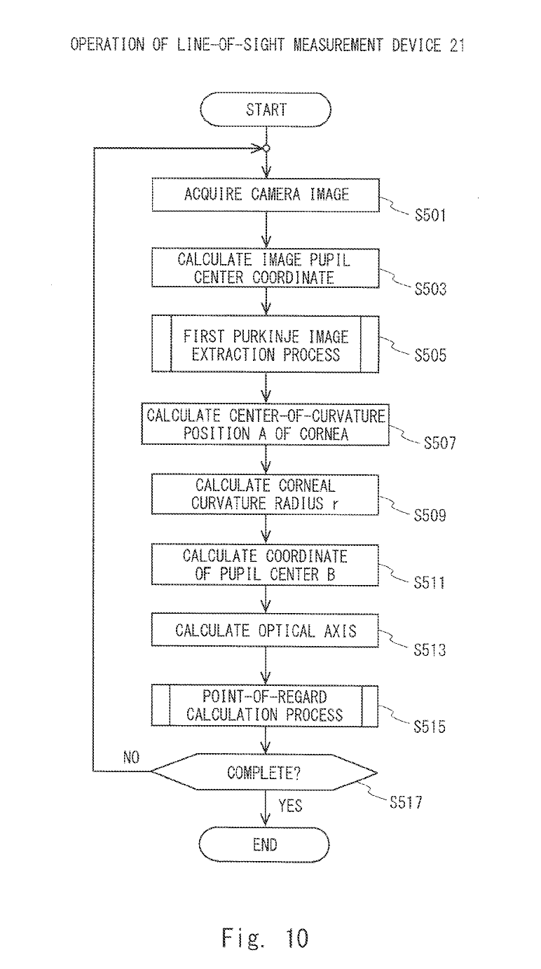

FIG. 10 is a flowchart showing operation of the CPU 211 of the line-of-sight measurement device 21.

The CPU 211 acquires images captured by the stereo cameras 219C0 and 219C1. The CPU 211 executes an optical axis calculation process in steps S503 to S513. The optical axis calculation process can be carried out by various existing techniques.

Further, the CPU 211 executes a point-of-regard calculation process (S515). In the point-of-regard calculation process, the CPU 211 calculates the actual point of regard of the subject viewing the displays 216. The CPU 211 repeatedly executes the process of steps S501 to S515 until the operation of the line-of-sight measurement device 21 is complete (S517).

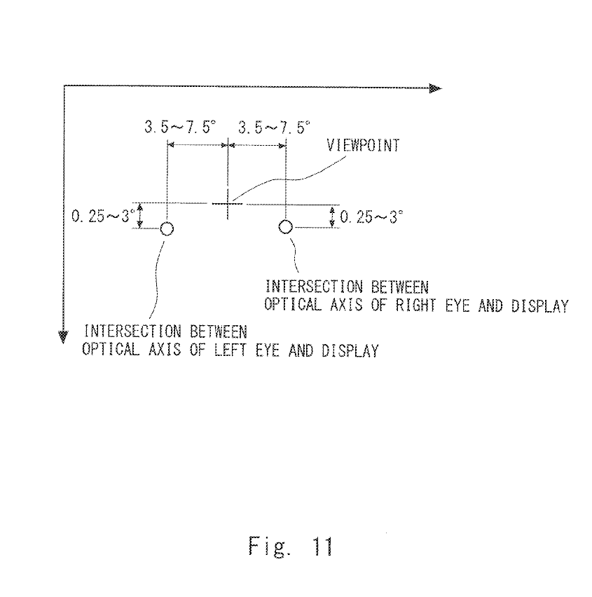

During the optical axis calculation process, the CPU 211 executes a process for extracting a first Purkinje image (which is a reflected image of the light source on a corneal surface). This process is carried out for the purpose of reducing errors occurring during the estimation of the optical axis. In the first Purkinje image extraction process, two reflected images, which are located at positions closer to the center of the image pupil, are selected from among three reflected images of the LEDs 218L0 to 218L2 that are displayed on the eyeball image captured by the stereo cameras 219C0 and 219C1 shown in FIG. 8. Thus, the optical axis is calculated using only reflected images in a portion having an approximately spherical shape. Furthermore, the CPU 211 executes the point-of-regard calculation process to correct a difference between the actual visual axis of the eyeball and the optical axis. This is because, in general, a point at which the subject is actually viewing does not match an intersection between the optical axis of each of the right and left eyes and the display, as shown in FIG. 11. Accordingly, a point (a point of regard) at which the subject gazes on the display 216a is estimated as a middle point between “the intersection between the display and the optical axis of the left eye” and “the intersection between the display and the optical axis of the right eye”.

In the line-of-sight measurement device 21 disclosed in Japanese Unexamined Patent Application Publication No. 2009-297323, an error in the point (point of regard) at which the subject gazes on the display 216a increases under the environment in which the distance between the subject and the display is not constant, for example, under the condition in which the distance between the subject and the display 216a of the line-of-sight measurement device 21 is changed during the use. This causes a problem that the line of sight cannot be normally detected. The cause of this problem will be described below.

The line-of-sight measurement device 21 acquires the reflected eyeball image by allowing the LEDs to emit light toward the subject viewing the display unit of the line-of-sight measurement device 21. Then, the line-of-sight measurement device 21 estimates the optical axis, which is an axis connecting the center of curvature of the cornea and the center of the pupil, from the eyeball image, and calculates the point of regard by use of the optical axis.

In the case of using the line-of-sight measurement device 21, it is necessary to measure the position of each LED in advance, calculate, by camera calibration, internal parameters such as a focal length, a central position of an image plane, and a coefficient of strain of a lens, and external parameters such as the position and direction of each camera, and preliminarily store the parameters into a hard disk. Accordingly, it is necessary to perform the camera calibration again when the distance (focal length) between the subject and the display 216a of the line-of-sight measurement device 21 is changed during the use.

For the reason described above, the distance between the subject and the display 216a of the line-of-sight measurement device 21 should be constant during the use after the camera calibration. When the distance between the subject and the display 216a of the line-of-sight measurement device 21 is changed, an error between the line of sight of the subject and the position of the line of sight (point of regard) on the display 216a of the line-of-sight measurement device 21, which is specified from the line of sight of the subject, increases. This makes it difficult to normally detect the line of sight.

On the other hand, according to an embodiment of the present invention, the preparation for each subject is not required, and line-of-sight detection can be performed without the need for calibration even when the environment is changed during the use of the line-of-sight detection apparatus.

Hereinafter, exemplary embodiments of the present invention will be described in detail with reference to the drawings.

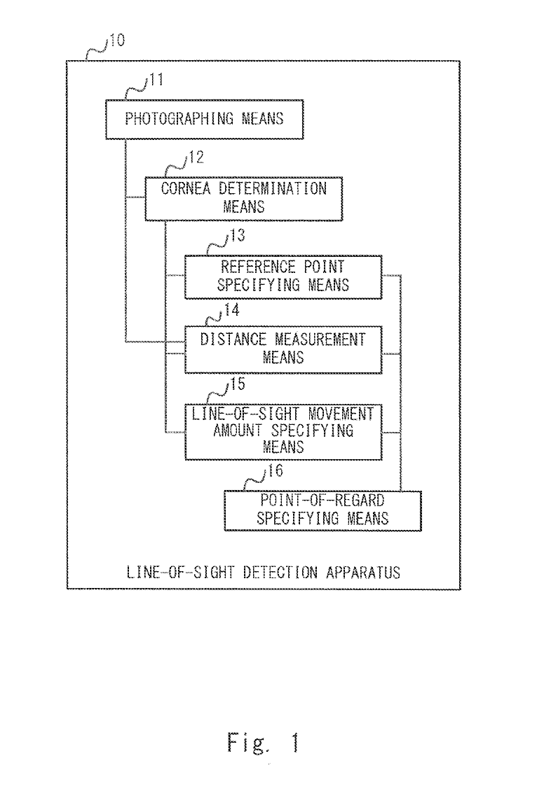

Referring first to FIG. 1, a configuration of a line-of-sight detection apparatus 10 according to an embodiment of the present invention will be described.

The line-of-sight detection apparatus 10 is an apparatus that photographs the face of the subject (not shown), in particular, the corneas of the eyes, to specify the position at which the subject is viewing on an object (not shown), that is, the point of regard. The term “object” herein described typically refers to an image displayed on a substantially planar display surface of each display (not shown).

The line-of-sight detection apparatus 10 includes photographing means 11, cornea determination means 12, reference point specifying means 13, distance measurement means 14, line-of-sight movement amount specifying means 15, and point-of-regard specifying means 16. These means are logical information processing means that are implemented by executing a program stored in a storage device (not shown) by a processor (not shown) included in the line-of-sight detection apparatus 10.

The photographing means 11 includes a camera having a zoom function to photograph a subject, and outputs an image (picture image) of the subject, which is obtained by photographing, and a magnification obtained during the photographing of the image as a zoom value. The term “zoom function” herein described refers to a function that changes the magnification of each image obtained by the camera. Examples of the zoom function include an optical zoom that changes the magnification of each image by an optical system, and a digital zoom that generates an image obtained by performing digital processing on an acquired image once to change the magnification thereof. Any mechanism can be employed as long as an equivalent function can be achieved. The camera described above can be replaced with any mechanism other than a camera, as long as an image of a subject can be obtained. In this embodiment, a camera having an optical zoom function or a digital zoom function will be described as the photographing means 11.

The cornea determination means 12 discriminates the corneas of the eyes of the subject from the image, which is obtained by photographing the subject by the photographing means 11, and outputs the image of the cornea. More specifically, the cornea determination means 12 has a face detection function, an eye detection function, and a cornea determination function. The face detection function receives the image output from the photographing means 11, detects the face from the image, and outputs image data on the face. The eye detection function receives the image data on the face output from the face detection function, detects the eyes from the image data, and outputs image data on the eyes. The cornea determination function receives the image data on the eyes output from the eye detection function, discriminates the corneas from the image data, and outputs image data on the corneas.

The reference point specifying means 13 receives each cornea image output from the cornea determination means 12, specifies the center of each eyeball of the subject based on the cornea image, specifies, as a reference point, an intersection between the object and a perpendicular line from the center of each eyeball to the object, and outputs the reference point.

The distance measurement means 14 receives the zoom value output from the photographing means 11 and the image data on the corneas output from the cornea determination means 12, calculates a distance between the object and the subject (more specifically, the corneas of the subject) based on the zoom value and the image data, and outputs the distance.

The line-of-sight movement amount specifying means 15 has a cornea movement amount measurement function and a line-of-sight movement amount specifying function. The cornea movement amount measurement function calculates and outputs a movement amount of each cornea (cornea movement amount) based on the image data on the corneas output from the cornea determination means 12. The line-of-sight movement amount specifying function receives the cornea movement amount output from the cornea movement amount measurement function and the distance between the object and each cornea specified by the distance measurement means 14, calculates a line-of-sight movement amount, which is a movement amount of the line of sight of the subject on the object, based on the cornea movement amount and the distance, and outputs the line-of-sight movement amount.

The point-of-regard specifying means 16 receives the reference point output from the reference point specifying means 13 and the line-of-sight movement amount output from the line-of-sight movement amount specifying means 15, calculates a point of regard indicating a position at which the subject gazes on the object, based on the reference point and the line-of-sight movement amount, and outputs the point of regard.

The point of regard output from the point-of-regard specifying means 16 can be input to a display device (not shown) and displayed so as to be superimposed on the object, for example. The point of regard can also be input to any other processing means and can be treated as a coordinate input by a known pointing device.

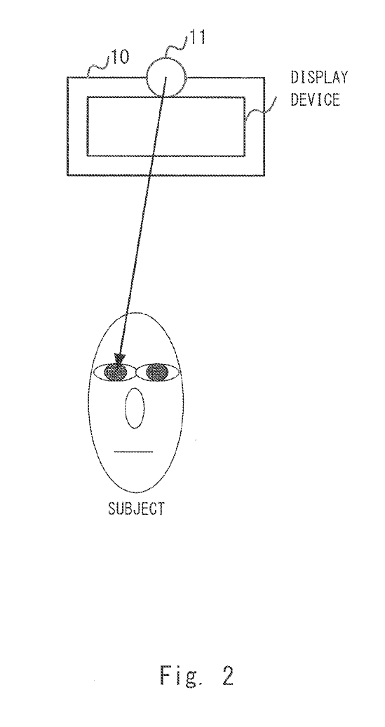

Referring next to FIG. 2, the usage environment of the line-of-sight detection apparatus 10 and the principle of the process for specifying the point of regard by the line-of-sight detection apparatus 10 will be described.

The photographing means 11 of the line-of-sight detection apparatus 10 is desirably installed such that the distance between the subject and the photographing means 11 is substantially equal to the distance between the subject and the display device that displays the object. Preferably, as shown in FIG. 2, the photographing means 11 is installed at a position substantially flush with the display surface of the display device. This allows the line-of-sight detection apparatus 10 to treat the distance (distance between the subject and the photographing means 11), which is calculated based on the image of the subject and the zoom value that are output from the photographing means 11, as the distance between the subject and the object.

As described above, the line-of-sight detection apparatus 10 calculates the cornea movement amount from the image of the subject photographed by the photographing means 11, and further calculates the line-of-sight movement amount on the object. When the distance between the subject and the line-of-sight detection apparatus 10 varies, the line-of-sight movement amount on the object also varies even with the same cornea movement amount. Accordingly, it is necessary to specify the distance between the object and the subject in order to specify the line-of-sight movement amount.

In the line-of-sight detection apparatus 10, the size of each cornea included in the image captured by the photographing means 11 and the zoom value obtained during the photographing of the image are used to specify the distance between the object and the subject. This is because, in general, when a size W1 of a photographic subject A in an image obtained by photographing the photographic subject A, which is located at a distance Y1 from the photographing means 11, according to a zoom value X1 is equal to a size W2 of the photographic subject A in an image obtained by photographing the photographic subject A, which is located at a distance Y2 from the photographing means 11, according to a zoom value X2, the following relational expression (1) holds.

Y2=(X2/X1)·Y1 (1)

Specifically, prior to the detection of a line of sight, the photographic subject A is photographed in advance by the photographing means 11. The distance (corresponding to Y1) between the photographing means 11 and the photographic subject A obtained at that time, the zoom value (corresponding to X1) obtained when the object is zoomed up, and the size (corresponding to W1) of the image of the photographic subject A are held as a reference value. In the case of actually detecting a line of sight, if the zoom value (corresponding to X2) can be obtained when the size (corresponding to W2) of the image of the photographic subject A is equal to the reference value (W1), the distance (corresponding to Y2) between the photographing means 11 and the photographic subject A obtained at that time can be derived from the relational expression (1) described above.

In this regard, the present inventor has found that a cornea of a subject is suitable as the photographic subject A. This is because the size of each cornea of humans of a certain age or older does not vary greatly among individuals. For this reason, a cornea of a certain subject can be photographed as a sample, and the reference value including the size (W1) of the image of the cornea in the image, the zoom value obtained during photographing, and the distance (Y1) can be preliminarily stored in the storage device or the like (not shown). This eliminates the need for any special preparation when the line-of-sight detection is carried out, and this makes it possible to derive the distance between the subject and the photographing means 11 only by zooming-up and photographing the subject such that the size (W2) of the image of each cornea of the subject is equal to the reference value (W1) of the size of the image.

While a cornea of a subject is herein used as a photographic subject for calculating the distance between the subject and the photographing means 11, the photographic subject is not limited thereto. Any photographic subjects can be used, as long as the size of each subject does not vary greatly among individuals.

Referring next to the flowchart of FIG. 2, the operation of the line-of-sight detection apparatus 10 will be described.

First, assume that the storage device (not shown) of the line-of-sight detection apparatus 10 preliminarily stores, as the reference value described above, the size of an image of a cornea (assuming that W1 represents the diameter of the cornea on the image; the size is hereinafter referred to as “basic size”), the distance (Y1) between the subject and the photographing means 11, which is obtained by photographing a cornea of a certain subject such that the cornea has the basic size, and the zoom value. In this case, the basic size is preferably a size that allows a movement of a line of sight to be detected to a satisfactory extent. Also assume that the storage device stores a magnification indicating how many times the actual size of the cornea is the basic size. The actual size of a cornea corresponds to the size of the image of the cornea obtained when the distance between the subject and the photographing means 11 is 0 and the zoom value is 1. In this case, the reference value and the magnification (hereinafter referred to as initial parameters) are not values that are required to be set every time prior to the use of the line-of-sight detection apparatus 10, but are numerical values to be preliminarily stored in the storage device during the manufacturing process of the line-of-sight detection apparatus 10, for example. The timing for storing the initial parameters is not limited to during the manufacturing process. The initial parameters can be stored at any timing prior to the use of the line-of-sight detection apparatus 10.

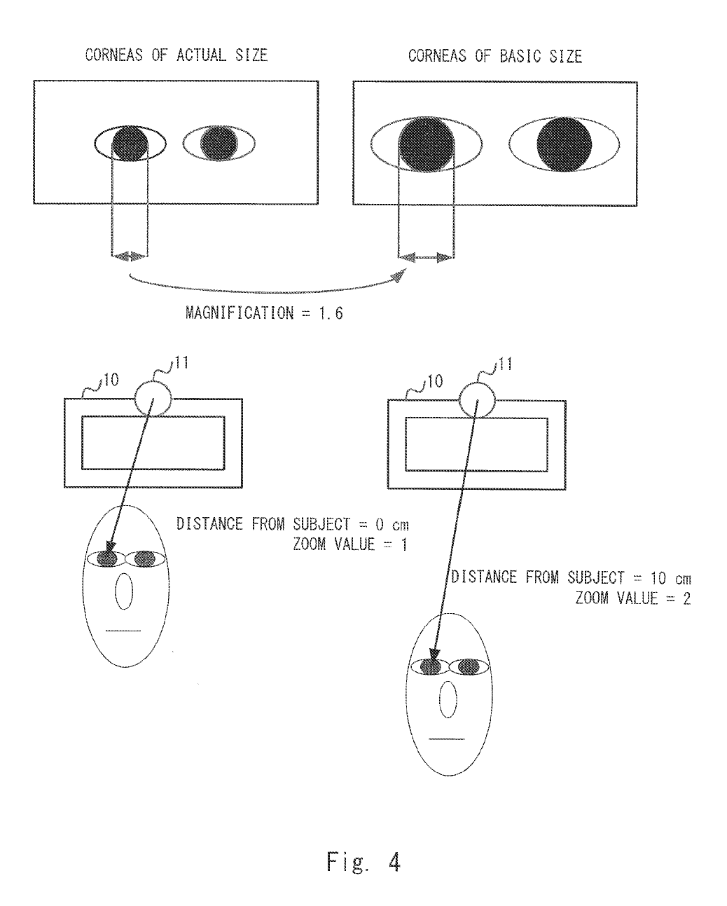

In this embodiment, as shown in FIG. 4, assume that the reference value including the basic size (W) of the image of each cornea=20 mm, the distance (Y1) between the subject and the photographing means 11=10 cm, and the zoom value (X2)=2, and the magnification=1.6 (the actual size of each cornea is 12 mm) are preliminarily stored in the storage device as initial parameters.

Next, the process in which the line-of-sight detection apparatus 10 detects the line of sight of the subject will be described.

F110: The photographing means 11 photographs the subject and outputs the captured image and the zoom value obtained during photographing. The cornea determination means 12 receives one image output from the photographing means 11, and detects the face of the subject from the image (face detection function). As a technique for detecting the face, a technique is known in which features of the face, such as the nose, ears, or eyebrows, are detected to specify the position of the face based on the detected features, for example. However, the technique is not limited thereto. Any technique can be employed as long as the face can be detected from the captured image.

The photographing means 11 preferably photographs the subject intermittently at a predetermined time interval and outputs captured images. The cornea determination means 12 preferably performs the process of sequentially discriminating corneas from these captured images.

F111: The cornea determination means 12 further detects the eyes of the subject from the face image detected by the face detection function (eye detection function). As a technique for detecting the eyes from the face image, a technique is known in which the position of each eye is specified by detecting a portion where the black-and-white edge, which is a feature of an eye, is clear, for example. However, the technique is not limited thereto. Any method can be employed as long as the eyes can be detected from the face image.

F112: The cornea determination means 12 further discriminates each cornea of the subject from the image of each eye detected by the eye detection function (cornea discrimination function). For example, a black portion in the image of each eye can be discriminated as the cornea. The cornea determination means 12 outputs the image of each cornea thus discriminated.

F120: The reference point specifying means 13 obtains the center point of each eyeball of the subject from the image of each cornea output from the cornea determination means 12. As a technique for obtaining the center of each eyeball from the image of each cornea, a technique is known in which the center of each eyeball is specified by defining a pupil as a circle or an ellipse and by obtaining the center of the pupil by a method of least squares or Hough transform. However, the technique is not limited thereto. Any method can be employed as long as the center of each eyeball can be detected from the image of each cornea.

Next, the reference point specifying means 13 draws a virtual perpendicular line from the center point of each eyeball to the object. The reference point specifying means 13 determines, as a reference point, a point at which the perpendicular line and the object, specifically, the display surface of the display device, intersect with each other.

F121: The distance measurement means 14 controls the zoom function of the photographing means 11 to zoom up each eye of the subject until the size of the image of each cornea reaches the basic size.

F121: When the zoom-up is completed, the distance measurement means 14 acquires, from the photographing means 11, the zoom value (X2) obtained at that time, that is, at the time when the image of each cornea has the same size (W2) as the basic size (W1). Further, the distance measurement means 14 acquires the initial parameters (X1 and Y1) from the storage device.

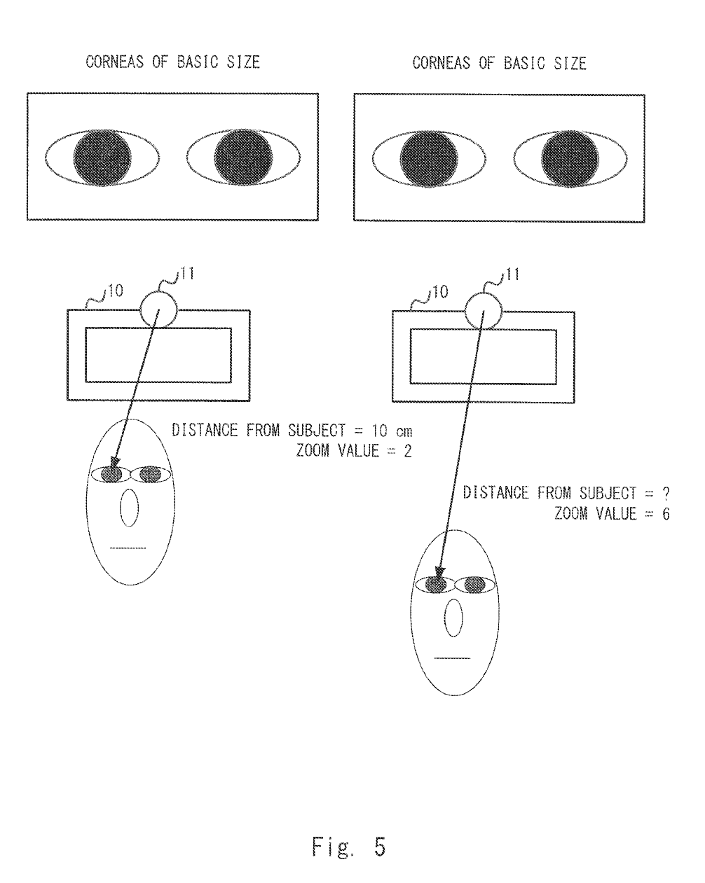

Next, the distance measurement means 14 substitutes the zoom value (X2), which is acquired from the photographing means 11, and the initial parameters (X1 and Y1) into the above-mentioned relational expression (1), and calculates the distance (Y2) between the photographing means 11 and the subject. As shown in FIG. 5, assuming that the zoom value obtained during the zoom-up to the basic size is 6, for example, the distance between the photographing means 11 and the subject is expressed as follows.

(6/2)×(10 cm)=30 cm

F130: The line-of-sight movement amount specifying means 15 first specifies the movement amount of the image of each cornea. The line-of-sight movement amount specifying means 15 receives, from the cornea determination means 12, a plurality of images of each cornea captured in time series. The plurality of images of each cornea can be generated in such a manner that the photographing means 11 photographs the subject at a predetermined time interval and outputs captured images and the cornea determination means 12 performs the process of sequentially discriminating each cornea from the captured images, for example. The line-of-sight movement amount specifying means 15 preferably compares, among the plurality of images of each cornea, the image used to specify the reference point in step F120, with one image which is captured after the image used to specify the reference point, to thereby obtain the movement amount of the image of each cornea. For example, a difference in an edge portion (a boundary between a black part and a white part of an eye) of an image of a cornea is obtained, and the difference thus obtained can be used as the movement amount of the image of the cornea. However, the technique for obtaining the movement amount of the image of each cornea is not limited thereto. Any technique can be employed as long as the movement amount of the image of each cornea can be calculated.

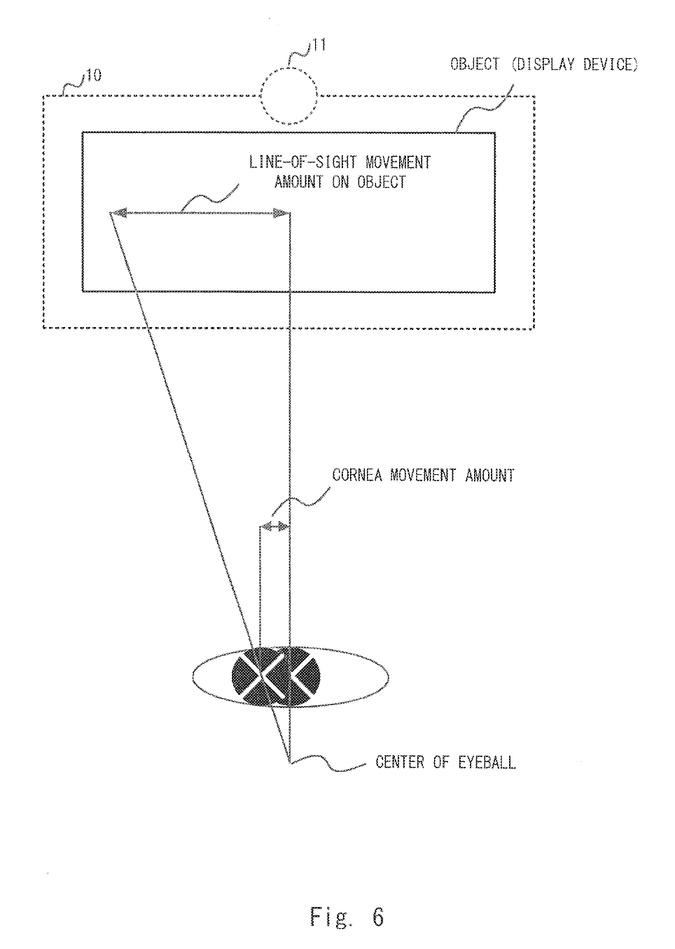

Next, as shown in FIG. 6, the line-of-sight movement amount specifying means 15 specifies the actual movement amount (cornea movement amount) of each cornea based on the movement amount of the image of each cornea. For example, the line-of-sight movement amount specifying means 15 multiplies the movement amount of the image of each cornea by the magnification of the initial parameters, thereby making it possible to calculate the cornea movement amount. Specifically, assuming that the image of the cornea moves 4 mm to the left when the photographing means 11 is viewed from the front, the basic size is 1.6 times the actual size of the cornea. Accordingly, the actual movement amount of the cornea is 4/1.6=2.5 mm to the left from the center of the object.

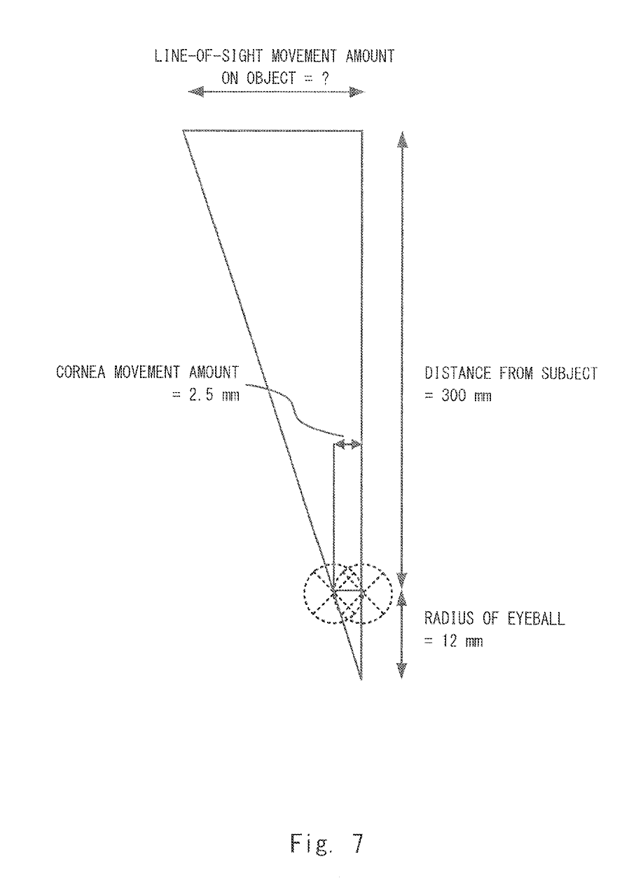

Further, as shown in FIG. 7, the line-of-sight movement amount specifying means 15 specifies the line-of-sight movement amount, which is the movement amount of the line of sight of the subject on the object, based on the cornea movement amount. In general, each cornea moves about the center of the corresponding eyeball. Accordingly, when the cornea moves about the center of the eyeball by the cornea movement amount, a right-angled triangle (hereinafter referred to as “triangle 1”) having a base corresponding to the radius of the eyeball and a height corresponding to the cornea movement amount is formed. Assume herein that a triangle 2 which is similar to the triangle 1 has a base corresponding to the sum of the radius of the eyeball and the distance between the photographing means 11 and the subject. At this time, the movement amount of the line of sight of the subject on the object corresponds to the height of the triangle 2. Also, assume herein that the photographing means 11 and the object are disposed at substantially the same distance and are substantially flush with each other.

That is, the line-of-sight movement amount (the height of the triangle 2) can be obtained by the following relational expression (2) based on the homothetic ratio between the triangle 1 and the triangle 2.

the height of the triangle 1(cornea movement amount): the height of the triangle 2(line-of-sight movement amount)=the base of the triangle 1(the radius of the eyeball): the base of the triangle 2(the radius of the eyeball+the distance between the photographing means 11 and the subject) (2)

In this regard, the present inventor has found that the distance from the base of the triangle 1 (the radius of the eyeball), that is, the center of each eyeball, to the corresponding cornea does not vary greatly among individuals of a certain age or older. Accordingly, the base of the triangle 1 (the radius of the eyeball) can be preliminarily stored in the storage device as a fixed value, and can be acquired and used during the calculation described above.

Therefore, the line-of-sight movement amount specifying means 16 can calculate the line-of-sight movement amount by using the cornea movement amount obtained by the above-mentioned technique and the predetermined radius of each eyeball, as well as the distance between the subject and the photographing means 11 which is output from the distance measurement means 14.

The line-of-sight movement amount specifying means 16 receives the distance between the photographing means 11 and the subject which is output from the distance measurement means 14. Further, the line-of-sight movement amount specifying means 16 calculates the line-of-sight movement amount by substituting the distance, the cornea movement amount, and the radius of the eyeball into the above-mentioned relational expression (2).

For example, assuming that the radius of the eyeball=12 mm, the distance between the photographing means 11 and the subject=300 mm, the cornea movement amount=2.5 mm, the relational expression (2) is expressed as follows.

2.5:X=12:312

Accordingly, the line-of-sight movement amount on the object can be specified as 65 mm.

F140: The point-of-regard specifying means 16 adds the line-of-sight movement amount, which is output from the line-of-sight movement amount specifying means 16, to the reference point, which is output from the reference point specifying means 13, thereby specifying the point of regard of the subject. For example, when the line-of-sight movement amount is 65 mm to the left, a point that is moved by 65 mm to the left from the reference point corresponds to the point of regard of the subject. The point-of-regard specifying means 16 outputs this point of regard.

F150: After these processes, the cornea determination means 12 receives, from the photographing means 11, the image of the subject captured at this time, and detects the latest position of the face of the subject by the face detection function. Then, the cornea determination means 12 compares the latest position of the face of the subject, preferably with the position of the face which is detected in F110 and obtained when the reference point is specified. In this case, when it is determined that the movement amount of the position of the face of the subject exceeds a predetermined threshold, the line-of-sight detection apparatus 10 executes the process of step F112 and subsequent steps again to specify the reference point and the point of regard again.

On the other hand, when it is determined that the movement amount of the position of the face of the subject does not exceed the predetermined threshold, the cornea determination means 12 discriminates each cornea of the subject from the received image, and compares the latest image of each cornea of the subject, preferably with the image of each cornea which is detected in F110 and obtained when the reference point is specified. In this case, when the image of each cornea of the subject is moved, the line-of-sight detection apparatus 10 executes the process of step F130 and subsequent steps again to specify the point of regard again. On the other hand, when the image of each cornea of the subject is not moved, the line-of-sight detection apparatus 10 executes the process of step F150 again.

According to this embodiment, the distance measurement means 14 can specify the distance between the photographing means 11 and the subject based on the size of the image of each cornea of the subject, which is discriminated by the cornea determination means 12 based on the image captured by the photographing means 11, and the zoom value of the photographing means 11. This eliminates the need for preparation and the like for each subject prior to the use of the line-of-sight detection apparatus 10. This is because the reference value including the size (W1) of the image of each cornea, the zoom value (X1) obtained during photographing, and the distance (Y1) is preliminarily stored in the storage device or the like (not shown) on the basis of the finding by the present inventor that the size of each cornea does not vary greatly among individuals. Consequently, in the case of detecting a line of sight, photographing while zooming up the size (W2) of the image of each cornea of the subject to be equal to the reference value (W1) of the size of the image enables derivation of the distance between the subject and the photographing means 11.

According to this embodiment, the line-of-sight movement amount specifying means 15 can calculate the line-of-sight movement amount based on the cornea movement amount and the distance between the subject and the photographing means 11 which is output from the distance measurement means 14. This is because the radius of each eyeball is preliminarily stored on the basis of the finding by the present inventor that the radius of each eyeball does not vary greatly among individuals.

According to this embodiment, the line-of-sight detection apparatus 10 monitors the position of the face of the subject as needed. Upon detecting a change in the position of the face, the line-of-sight detection apparatus 10 specifies the position of the face, the position of each eye, and the position of each cornea again, calculates the distance again, and specifies the reference point and the point of regard again. This makes it possible to normally detect a line of sight without the need for each explicit calibration and without causing an error in the point of regard, even under the environment in which the distance between the subject and the photographing manes 11 is changed during the use of the line-of-sight detection apparatus 10.

### Other Embodiments

Note that the present invention is not limited only to the embodiments described above, but can be modified in various manners without departing from the scope of the present invention.

For example, the embodiments described above have illustrated a configuration in which the basic size of an image of a cornea, the zoom value obtained when the image is captured, the distance, and the like are preliminarily stored as the reference value and the photographing means 11 is configured to zoom up the image of the cornea to the basic size during the detection of the actual line of sight. This is based on the premise that one type of reference value is used. However, the reference value is not necessarily one type. A plurality of reference values that are associated with the size of an image of a cornea, the zoom value, and the distance may be stored in a storage device. In this case, the distance measurement means 14 uses the reference value that is equal or most approximate to the size of the cornea image output from the cornea determination means 12. This makes it possible to measure the distance between the subject and the photographing means 11 at high speed, while minimizing the use of the zoom function of the photographing means 11. This allows the distance measurement means 14 to perform high-speed processing. In this case, however, the size of the cornea image to be set as the reference value preferably falls within the range of sizes that allow a movement of a line of sight to be detected to a satisfactory extent.

Also in the case of storing a plurality of reference values in advance, the line-of-sight detection apparatus 10 may store the size of the cornea image optimum for detecting the movement of the line of sight, so as to be distinguishable from others. In this case, in the case of executing step F121 first, the line-of-sight detection apparatus 10 can specify the distance from the subject by using the reference value including the optimum size of the cornea image. This makes it possible to take full advantage of the zoom function and precisely measure the distance from the subject, upon starting the execution of the detection of a line of sight. On the other hand, in the case of detecting the movement of the position of the face of the subject in F150 and executing step F121 again, the reference value that is equal or most approximate to the size of the cornea image output from the cornea determination means 12 can be used among the plurality of reference values. This makes it possible to minimize the use of the zoom function of the photographing means 11, measure the distance from the subject again at high speed, and suppress a delay in the line-of-sight detection process, during the execution of the line-of-sight detection.

For example, while the movement of the position of the face of the subject is detected in step F150 in the embodiments described above, the face need not necessarily be detected. Any feature points other than a face can be used as long as the movement of the subject can be detected.

The operations of the reference point specifying means 13 and the distance measurement means 14 in the embodiments described above may be executed in reverse order or in parallel.

Although embodiments have been described above as a hardware configuration, the present invention is not limited thereto. The present invention can also be implemented by causing a CPU (Central Process Unit) to execute arbitrary processing as a computer program.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. A line-of-sight detection apparatus that specifies a point of regard indicating a position at which a subject gazes within a substantially planar object, the line-of-sight detection apparatus comprising:
a photographing unit that photographs the subject and outputs an image obtained by the photographing and a zoom value, the photographing unit having a zoom function;
a cornea determination unit that discriminates an image of a cornea of the subject from the image;
a reference point specifying unit that specifies a center of an eyeball of the subject based on the image of the cornea, and specifies, as a reference point, an intersection between the object and a perpendicular line from the center of the eyeball to the object;
a distance measurement unit that specifies a zoom value indicating a predetermined size of the image of the cornea, and specifies a distance from the cornea to the object based on the zoom value;
a line-of-sight movement amount specifying unit that specifies a movement amount of the cornea based on a movement amount of the image of the cornea, and specifies a line-of-sight movement amount on the object based on the movement amount of the cornea and the distance from the cornea to the object; and
a point-of-regard specifying unit that specifies the point of regard based on the reference point and the line-of-sight movement amount.

2. The line-of-sight detection apparatus according to claim 1, wherein upon detecting a change in the position of the subject, the distance measurement unit and reference point specifying unit specify the distance from the cornea to the object again and specify the reference point again.

3. The line-of-sight detection apparatus according to claim 1, wherein
the distance measurement unit acquires a size of an image of a cornea as a reference value, a zoom value as a reference value, and a distance from the cornea to the object as a reference value, the size of the image, the zoom value, and the distance being preliminarily stored,
the distance measurement unit controls the zoom function of the photographing unit such that the size of the image of the cornea is equal to the size of the image of the cornea acquired as the reference value, and
the distance measurement unit specifies the distance from the cornea to the object based on a zoom value used during the control, the zoom value acquired as the reference value, and the distance from the cornea to the object acquired as the reference value.

4. The line-of-sight detection apparatus according to claim 1, wherein the line-of-sight movement amount specifying unit specifies the line-of-sight movement amount by using the distance from the center of the eyeball to the cornea, the distance being preliminarily stored.

5. A line-of-sight detection method that specifies a point of regard indicating a position at which a subject gazes within a substantially planar object, the line-of-sight detection method comprising:
a photographing step of photographing, by a photographing unit having a zoom function, the subject, and outputting an image obtained by the photographing and a zoom value;
a cornea determination step of discriminating an image of a cornea of the subject from the image;
a reference point specifying step of specifying a center of an eyeball of the subject based on the image of the cornea, and specifying, as a reference point, an intersection between the object and a perpendicular line from the center of the eyeball to the object;
a distance measurement step of specifying a zoom value indicating a predetermined size of the image of the cornea, and specifying a distance from the cornea to the object based on the zoom value;
a line-of-sight movement amount specifying step of specifying a movement amount of the cornea based on a movement amount of the image of the cornea, and specifying a line-of-sight movement amount on the object based on the movement amount of the cornea and the distance from the cornea to the object; and
a point-of-regard specifying step of specifying the point of regard based on the reference point and the line-of-sight movement amount.

6. The line-of-sight detection method according to claim 5, wherein when a change in the position of the subject is detected, the distance measurement step and the reference point specifying step are executed again.

7. The line-of-sight detection method according to claim 5, wherein the distance measurement step includes:
acquiring a size of an image of a cornea as a reference value, a zoom value as a reference value, and a distance from the cornea to the object as a reference value, the size of the image, the zoom value, and the distance being preliminarily stored;
controlling the zoom function in the photographing step such that the size of the image of the cornea is equal to the size of the image of the cornea acquired as the reference value; and
specifying the distance from the cornea to the object based on a zoom value used during the control, the zoom value acquired as the reference value, and the distance from the cornea to the object acquired as the reference value.

8. The line-of-sight detection method according to claim 5, wherein the line-of-sight movement amount specifying step includes specifying the line-of-sight movement amount by using the distance from the center of the eyeball to the cornea, the distance being preliminarily stored.

9. A non-transitory computer readable medium storing a program for causing a computer to execute the line-of-sight detection method according to claim 5.
